(19) United States
(12) Patent Application Publication
(10) Pub. No.: US 2012/0191521 A1
(43) Pub. Date: Jul. 26, 2012

(54) INTELLIGENT ELECTRONIC SHOPPING SYSTEM

(76) Inventor: Diwakar Kumawat, Foster City, CA (US)

(21) Appl. No.: 13/011,055

(22) Filed: Jan. 21, 2011

(51) Int. Cl. G06Q 30/00

(52) U.S. Cl. 705/14.23

(57) ABSTRACT

A method for preventing unintended discounts and frauds in an intelligent electronic shopping system includes providing a user with a first discount, a second discount, and a third discount from a service provider and storing rules in a promotion rule module, wherein the rules define that the first discount is combinable with the second discount or the third discount and that the second discount and the third discount are not combinable with each other. A first price for the order is computed based on the combination of the first discount and the second discount. A second price for the order is computed based on the combination of the first discount and the third discount. The user selects the first price or the second price to pay for the order.

### BACKGROUND OF THE INVENTION

The present application relates to an electronic shopping system, in particular, to an electronic shopping system capable of handling complex multiplicative discounts.

In recent years, electronic commerce has grown rapidly in many parts of the world. Customers can order pre-made commodities from websites provided by online retailers such as Amazon.com, Inc., Best Buy, and Wal-mart, Inc. Customers can also create personalized products such as image products using their own photos at websites provided by image service providers. The customers first upload digital images to a central sever provided by an image service provider. The customers can store, organize, edit, enhance, and share digital images at the central network location. The customers can also design and order image-based products such as personalized photo calendars, greeting cards, and photo books from the image service provider. A high degree of personalization can be achieved to make the image-based products memorable.

To promote product sales, online retailers and image service providers often provide discounts as incentives to the customers. Each customer may, at one time, receive multiple promotion offers. Some of these offers, however, may be in conflict with each other. Some combination of promotions may produce unintended discounts and are also vulnerable to frauds.

There is therefore a need for an intelligent electronic shopping system that can prosecute payments on customers' orders while properly handling complex multiplicative promotions to the customers.

### SUMMARY OF THE INVENTION

In one aspect, the present application relates to a method for preventing unintended discounts and frauds in an intelligent electronic shopping system. The method includes providing a user with a first discount, a second discount, and a third discount from a service provider; allowing the user to select or create one or more products; capturing the order comprising the one or more products in a shopping cart; storing rules in a promotion rule module, wherein the rules define that the first discount is combinable with the second discount or the third discount and that the second discount and the third discount are not combinable with each other; applying the first discount, the second discount, and the third discount to the order by a dynamic price engine according to the rules, which calculates a first price for the order based on the combination of the first discount and the second discount and calculates a second price for the order based on the combination of the first discount and the third discount, wherein the dynamic price engine prohibits the combination of the second discount and the third discount in computing the price for the order; allowing the user to select the first price for the order based on the combination of the first discount and the second discount or the second price for the order based on the combination of the first discount and the third discount; facilitating the user to pay for the order at the first price or the second price selected by the user; and fulfilling the one or more products in the order at a product fulfillment center.

Implementations of the system may include one or more of the following. The method can further include storing at least a portion of the first discount, the second discount, and the third discount prior to the creation of the order by the user. The method can further include receiving at least a portion of the first discount, the second discount, and the third discount an external source outside of the intelligent electronic shopping system. The method can further include providing, to the user, at least a portion of the first discount, the second discount, and the third discount in response to the user's behavior in selecting, creating, and purchasing products. The method can further include allowing the user to enter a discount code comprising at least a portion of the first discount, the second discount, and the third discount. The first discount, the second discount, and the third discount can provide different percentages or price reductions to different users, and wherein the rules are the same for the different users. The first discount, the second discount, and the third discount can provide a price reduction by a predetermined percentage or a fixed amount for the one or more products.

In another aspect, the present application relates to a network-based product-fulfillment system that includes one or more servers operated by a service provider and configured to allow a user to select or create one or more products in an order over a computer network, wherein the user has received a first discount, a second discount, and a third discount from the service provider; a shopping cart that can capture the order comprising the one or more products; a promotion rule module that can store rules that define that the first discount is combinable with the second discount or the third discount and that the second discount and the third discount are not combinable with each other; a dynamic price engine in communication with the promotion rule module and the shopping cart, the dynamic price engine being configured to apply the first discount, the second discount, and the third discount to the order according to the rules, which calculates a first price for the order based on the combination of the first discount and the second discount, wherein the dynamic price engine prohibits the combination of the second discount and the third discount in computing the price for the order; a checkout module in communication with the shopping cart, the checkout module being configured to facilitate the user to pay for the order; and a product fulfillment center that can fulfill the one or more products in the order.

Implementations of the system may include one or more of the following. The one or more servers can receive one or more digital images from the user and allow the user to incorporate the one or more digital images into the one or more products, wherein the one or more products include personalize image products. The personalize image products can include at least one selected from the group consisting of photo books, personalized greeting cards, photo stationery, photo or image prints, photo posters, photo banners, photo playing cards, photo T-shirts, photo coffee mugs, photo pads, photo key-chains, photo collectors, and photo coasters. At least a portion of the computer network can communicate in wireless signals. The network-based product-fulfillment system can further include a storage device in communication with the dynamic price engine and configured to store at least a portion of the first discount, the second discount, and the third discount prior to the creation of the order by the user. At least a portion of the first discount, the second discount, and the third discount can be provided to the user as a response to the user's behavior in selecting, creating, and purchasing products. The dynamic price engine can calculate a second price for the order based on the combination of the first discount and the third discount, wherein the checkout module can facilitate the user to pay for the order at the first price or the second price chosen by the user. The first discount, the second discount, and the third discount can provide different percentages or price reductions to different users, and wherein the rules are the same for the different users. The first discount, the second discount, and the third discount can provide a price reduction by a predetermined percentage or a fixed amount for the one or more products.

In another aspect, the present application relates to a intelligent electronic shopping system operated by a service provider which includes a shopping cart that can capture an order comprising one or more products selected or created by a user who has received a first discount, a second discount, and a third discount from the service provider; a promotion rule module that can store rules that define that the first discount is combinable with the second discount or the third discount and that the second discount and the third discount are not combinable with each other; a dynamic price engine in communication with the promotion rule module and the shopping cart, the dynamic price engine being configured to calculate a first price for the order based on the combination of the first discount and the second discount, wherein the dynamic price engine prohibits the combination of the second discount and the third discount in computing the price for the order; and a checkout module in communication with the shopping cart, the checkout module being configured to facilitate the user to pay for the order, wherein the order is sent to a product fulfillment center.

Implementations of the system may include one or more of the following. The dynamic price engine can compute a second price for the order based on the combination of the first discount and the third discount. The checkout module can facilitate the user to pay for the order at the first price or the second price chosen by the user. At least a portion of the first discount, the second discount, and the third discount can be received from an external source outside of the intelligent electronic shopping system. At least a portion of the first discount, the second discount, and the third discount can be provided to the user as a response to the user's behavior in selecting, creating, and purchasing products. At least a portion of the first discount, the second discount, and the third discount can be entered as a discount code by the user. The first discount, the second discount, and the third discount can provide different percentages or price reductions to different users, and wherein the rules are the same for the different users.

Embodiments may include one or more of the following advantages. The disclosed intelligent electronic shopping system can prevent the combinations of discount offers that are not meant to be combined, thus avoiding larger-than-intended discounts and losses in revenues to the online retailers.

The disclosed intelligent electronic shopping system can prevent discount conflicts and prevent frauds that attempt to take advantages of the multiplicative discounts. The disclosed intelligent electronic shopping system can provide options to the customers as to which promotions are applied.

The disclosed intelligent electronic shopping system can also provide clear communications or options to customers about which and how promotions are applied to their orders.

### BRIEF DESCRIPTION OF THE DRAWINGS

FIG. 1 is a block diagram for a network-based product-fulfillment system for producing personalized image-based products.

FIG. 2 is a block diagram for an intelligent shopping system compatible with the network-based product-fulfillment system of FIG. 1.

FIG. 3 illustrates different types of discounts received by a user.

FIG. 4 illustrates rules that govern if and how different types of discounts can be combined in an order.

FIG. 5 is a flowchart for intelligently applying a combination of discounts in the intelligent shopping system compatible with the network-based product-fulfillment system of FIG. 1.

Although the invention has been particularly shown and described with reference to multiple embodiments, it will be understood by persons skilled in the relevant art that various changes in form and details can be made therein without departing from the spirit and scope of the invention.

### DETAILED DESCRIPTION OF THE INVENTION

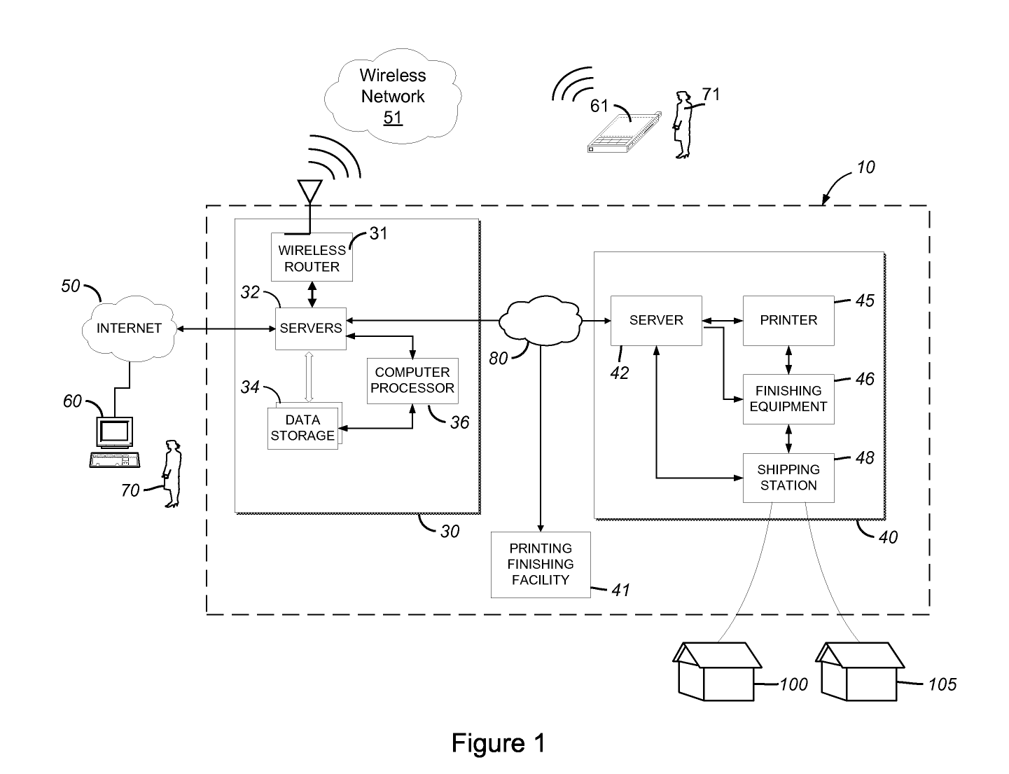

FIG. 1 shows a block diagram of a network-based product-fulfillment system 10 for selling and fulfilling products to users 70, 71 via a wired or wireless network. The network-based product-fulfillment system 10 can include a data center 30, one or more product fulfillment centers 40 and 41, and a computer network 80 that facilitates the communications between the data center 30 and the product fulfillment centers 40 and 41.

The network-based product-fulfillment system 10 can be established by an online retailer that sell pre-made off-the-shelf commodities such as electronic devices, apparel, household items, tickets, movies, and books. The network-based product-fulfillment system 10 can also provide products that require significant user participation in designs and personalization. For example, these products include personalized image-based products provided by companies such as Shutterfly, Inc. In the present disclosure, the term “personalized” is used in personalized content, personalized messages, personalized images, and personalized designs that can be incorporated in the personalized products. The term “personalized” refers to the information that is specific to the recipient, the user, the gift product, and the occasion. The content of personalization can be provided by a user or selected by the user from a library of content provided by the service provider. The personalized image-based products can include users' photos, personalized text, and personalized designs. The content provided can include text, images, and content licensed from a third party. The term “personalized information” can also be referred to as “individualized information” or “customized information”. Examples of personalized image-based products may include photo books, personalized greeting cards, photo stationery, photo or image prints, photo posters, photo banners, photo playing cards, photo T-shirts, photo coffee mugs, photo pads, photo key-chains, photo collectors, photo coasters, or other types of photo gift or novelty item. The term “photo book” refers to books that include one or more pages and at least one image on a book page. Photo books can include photo albums, scrapbooks, bound photo calendars, or photo snap books, etc.

The data center 30 can include a server 32 for communicating and receiving input from the users 70, 71, a data storage device 34 for storing user data, image and design data, and a computer processor 36 for processing orders and rendering digital images. The user data can include user account information, user discount information, and order information.

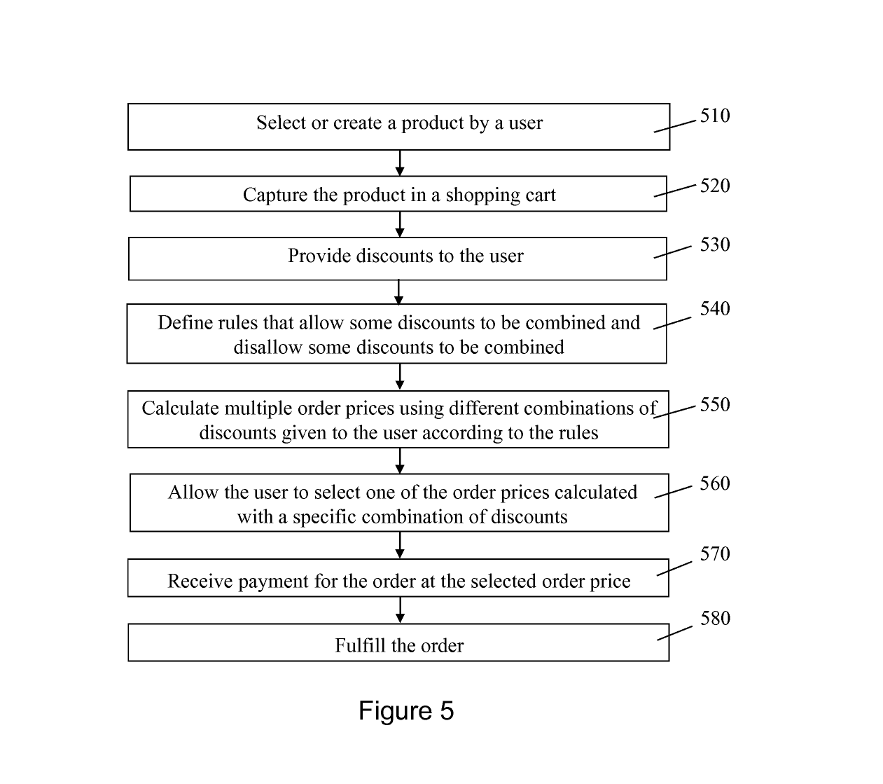

A website can be powered by the servers 32, which the user 70 can access via the Internet 50 using a computer device 60. The website can also be accessed by the user 71 via a wireless network 51 using a wireless device 61. Referring to FIGS. 1-2 and 5, the users 70, 71 can select or create products at the web interface facilitated by a product selection/creation module 210 in the server 32 (FIG. 5, step 510). The user can select off-the-shelf products from a product catalog 220. The user can select designs from product designs 225 and incorporate images newly uploaded or stored in the image archive 330 into the product that the user is to create. The product catalog 220, the product designs 225 and the image archive 230 can be stored in the data storage 34.

After a product is created, the user 70, 71 can purchase the product with the assistance of an intelligent electronic shopping system 200. When the user 70, 71 is ready to order the product (usually by clicking an “order” button), the product is captured by a shopping cart 240 (FIG. 5, step 520).

To promote product sales, online retailers and image service providers often provide discounts as incentives to the customers. The users 70, 71 may receive multiple promotion offers by the service/product provider that hosts the network-based product-fulfillment system 10 (FIG. 5, step 530). The previously received discounts are stored in a stored user discount 260. Some discounts can be dynamically generated according to the user behaviors 265. Some users may be referred or directed from another web site and these users may be given discounts based on using external user data 270.

There can be many types of discounts depending on the specific situation in which they are generated. A first type of discounts can include catalog offers, which includes 20% discount on product A, 30% discount on product B, purchase a product C and gets 50% discount on additional product C, and purchase a product A and gets a product B free. The first type of discounts can also include pre-paid saving plans, volume discounts, free products given to new users, and free shipping. A common theme for the first type of discounts is that they are applicable to all qualified customers.

Some first type of discounts can be dynamically generated in response to user behaviors 265. For example, when a user is ready to order a first product C within a session, the user can be informed about a new discount on additional product C at 30% discount.

Another type of discounts is related to specific segments of customers who have received promotions in specific marketing programs. For example, some customers received promotions in printed advertisements; some receive promotions in the last orders they used; some customers received discounts through a partners' marketing drive, (which can be entered by the users and stored in the user discounts 260). A common theme for the second type of discounts is that they are applicable only specifically to each segment of customers.

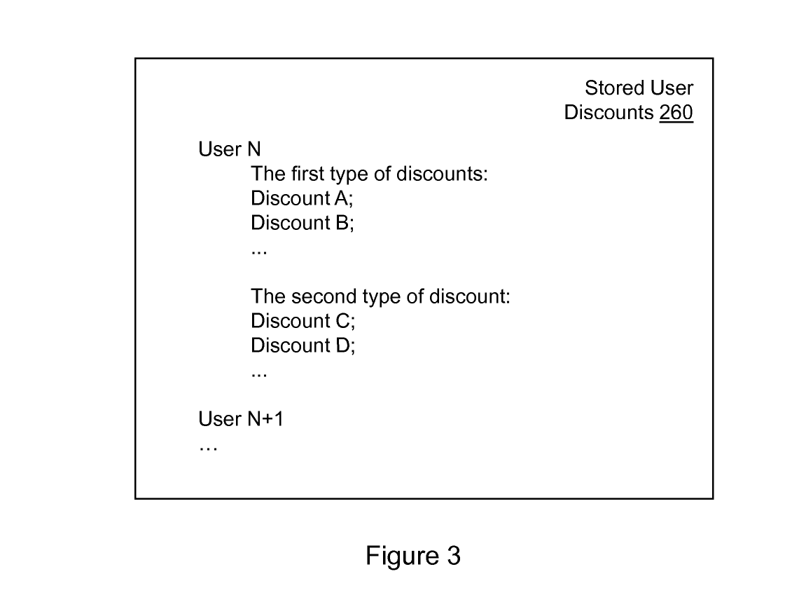

The stored user discount 260, as shown in FIG. 3, can store the first type of discounts (discount A, discount B . . . ) and the second type of discounts (discount C, discount D . . . ) for each user. The discounts can be saved by the product/service provider, or entered by the user 70, 71 in the form of promotional codes. Similarly, both types of discounts can also be generated in accordance to user behaviors 265 and the external user data 270. It should also be noted that the discounts, regardless its sources, can be customized to a user. For example, a user having a “Gold” membership with the service or product provider may be given bigger discounts (in absolute dollar amount or in percentages) than other members. The “Gold” member may also be given discounts that combine more different products such as buy a photobook and get 10 free greeting cards, or buy 2 calendars to get free shipping, which may not be available to other members.

It should be noted that there can be more than two types of discounts, for example, a third type, a fourth type etc. in addition to the first and the second types. Some types of these discounts (similar o the first type) are combinable among the same type of discounts as well as with other types of discounts. Some types of these discounts (similar o the second type) are not combinable among the same type of discounts but can be combined with other types of discounts.

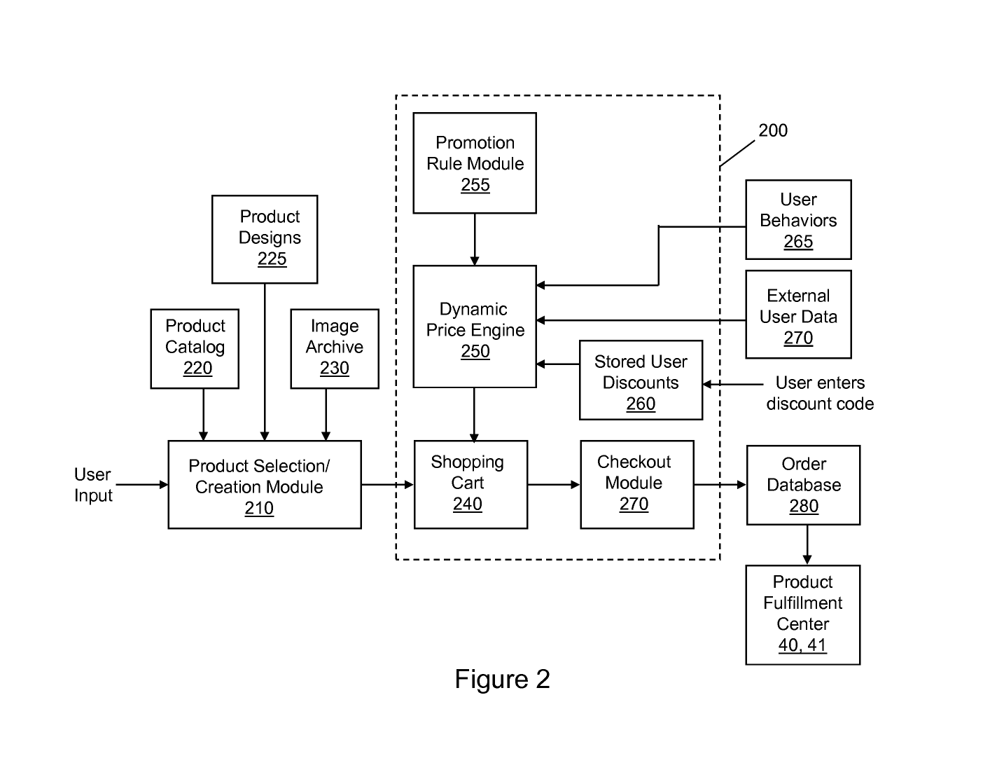

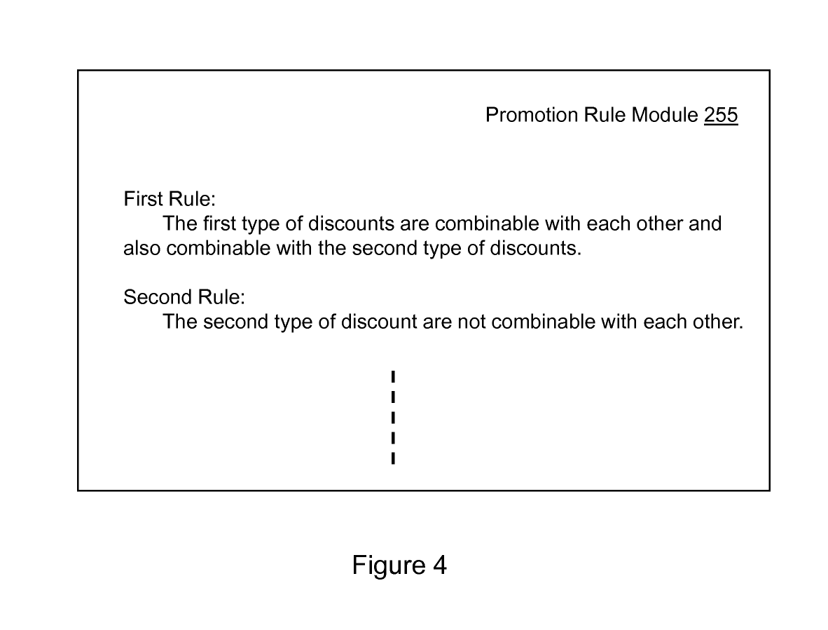

As shown in FIGS. 2-5, a promotion rule module 255 in the intelligent shopping system 200 stores rules that govern how different types of discounts can be combined (FIG. 5, step 540). The rules are generally applicable to all the users. For example, the first rule can define that the first type of discounts (Discounts A, B . . . in FIG. 3) are combinable with each other and are also combinable with the second type of discounts (Discounts C, D . . . in FIG. 3). The second rule defines that the second type of discount (Discounts C, D . . . in FIG. 3) are not combinable with each other. Examples of the second type of discounts include a promotion 30% off through an affiliate program and an email promotion also promotes 30% discounts. The two second-type discounts are not combinable to give a 51% discount (FIG. 5, step 540). It should be noted that although the extent of discounts and the types of discounted products may differ among users (depending user behavior, membership, and partnership etc.), the rules for combining discounts stored in the promotion rule module 255 are generally applicable to different users.

After the product created or selected by the user 70, 71 is captured by the shopping cart 240, a dynamic price engine 250 receives the discounts applicable to the user from the stored user discounts 260, discount related to the user behaviors 265, and from the external user data 270 such as partner's site. The shopping cart 240 can also allow the user to enter promotion codes for that specific order. The dynamic price engine 250 then calculates price for the order and applies the discounts based on the rules defined in the promotion rule module 255. Only allowable combinations of discounts can be applied together to an order.

The list of product items is then presented by a checkout module 270 at the web interface to the user 70, 71. The user 70, 71 may be presented with several price options with different allowed discount combinations (FIG. 5, step 550). For example, two combinable discounts can include $10 off a book and 10% off an order. Two different order prices can be obtained when the two discounts are applied in different orders. For a $30 photobook, applying 10% off discount then $10 off leads to a $17 order price after discounts; applying $10 off and then 10% discount leads to an $18 order price after discounts. Both order prices and the associated discount sequences are presented to the user by the checkout module 270. The user is allowed to choose one of the discount options which usually a desirable price (FIG. 5, step 560). The user is also allowed to cancel one discount in the final price calculation. In some situations, the user wants to save that discount for another order.

After the user 70, 71 selects the discount she wants, the order is paid by the user 70, 71 in the checkout module 270 (FIG. 5, step 570). The order is stored in an order database 280 and then sent to product a fulfillment center 40, 41, which produces the ordered products (FIG. 5, step 580), and deliver the recipients (100, 105 in FIG. 1) specified by the user 70, 71. The product fulfillment center 40 includes a server 42, and the storage and retrieving systems for pre-made off-the-shelf products. For the fulfillments of personalized image products, the product fulfillment center 40 can include one or more printers 45 for printing images, finishing equipment 46 for operations such as cutting, folding, binding the printed image sheets, and shipping stations 48 for verifying the orders and shipping the orders to recipients 100 and 105. Examples of the printers 45 include can be digital photographic printers, offset digital printers, digital printing presses, and inkjet printers. The finishing equipment 46 can perform operations for finishing a complete image-based product other than printing, for example, cutting, folding, adding a cover to photo book, punching, stapling, gluing, binding, and envelope printing and sealing. The shipping stations 48 may perform tasks such as packaging, labeling, package weighing, and postage metering.

It should be noted that the detailed configurations and steps can differ from the examples described above without deviating from the spirit of the present invention. The discounts can include other types, be derived from other sources, and in different combinations. The present invention can be applicable to many other types of products than the ones used in the above examples. The fulfillment of products can be achieved by other types of equipment or provided by third parties.

What is claimed is:

1. A method for preventing unintended discounts and frauds in an intelligent electronic shopping system, comprising:
providing a user with a first discount, a second discount, and a third discount from a service provider;
allowing the user, by one or more computer servers, to select or create one or more products;
capturing the order comprising the one or more products in a shopping cart;
storing rules in a promotion rule module, wherein the rules define that the first discount is combinable with the second discount or the third discount and that the second discount and the third discount are not combinable with each other;
applying the first discount, the second discount, and the third discount to the order by a dynamic price engine according to the rules, which calculates a first price for the order based on the combination of the first discount and the second discount and calculates a second price for the order based on the combination of the first discount and the third discount, wherein the dynamic price engine prohibits the combination of the second discount and the third discount in computing the price for the order;
allowing the user to select the first price for the order based on the combination of the first discount and the second discount or the second price for the order based on the combination of the first discount and the third discount;
facilitating the user to pay for the order at the first price or the second price selected by the user; and
fulfilling the one or more products in the order at a product fulfillment center.

2. The method of claim 1, further comprising storing at least a portion of the first discount, the second discount, and the third discount prior to the creation of the order by the user.

3. The method of claim 1, further comprising receiving at least a portion of the first discount, the second discount, and the third discount an external source outside of the intelligent electronic shopping system.

4. The method of claim 1, further comprising producing at least a portion of the first discount, the second discount, and the third discount in response to the user's behavior in selecting, creating, and purchasing products.

5. The method of claim 1, further comprising allowing the user to enter a discount code comprising at least a portion of the first discount, the second discount, and the third discount.

6. The method of claim 1, wherein the first discount, the second discount, and the third discount provides different percentages or price reductions to different users, and wherein the rules are the same for the different users.

7. A network-based product-fulfillment system, comprising:
one or more servers operated by a service provider and configured to allow a user to select or create one or more products in an order over a computer network, wherein the user has received a first discount, a second discount, and a third discount from the service provider;
a shopping cart configured to capture the order comprising the one or more products;
a promotion rule module configured to store rules that define that the first discount is combinable with the second discount or the third discount and that the second discount and the third discount are not combinable with each other;
a dynamic price engine in communication with the promotion rule module and the shopping cart, the dynamic price engine being configured to apply the first discount, the second discount, and the third discount to the order according to the rules, which calculates a first price for the order based on the combination of the first discount and the second discount, wherein the dynamic price engine prohibits the combination of the second discount and the third discount in computing the price for the order;
a checkout module in communication with the shopping cart, the checkout module being configured to facilitate the user to pay for the order; and
a product fulfillment center configured to fulfill the one or more products in the order.

8. The network-based product-fulfillment system of claim 7, wherein the one or more servers are configured to receive one or more digital images from the user and allow the user to incorporate the one or more digital images into the one or more products, wherein the one or more products include personalize image products.

9. The network-based product-fulfillment system of claim 8, wherein the personalize image products comprises at least one selected from the group consisting of photo books, personalized greeting cards, photo stationery, photo or image prints, photo posters, photo banners, photo playing cards, photo T-shirts, photo coffee mugs, photo pads, photo key-chains, photo collectors, and photo coasters.

10. The network-based product-fulfillment system of claim 7, wherein at least a portion of the computer network communicates in wireless signals.

11. The network-based product-fulfillment system of claim 7, further comprising a storage device in communication with the dynamic price engine and configured to store at least a portion of the first discount, the second discount, and the third discount prior to the creation of the order by the user.

12. The network-based product-fulfillment system of claim 7, wherein at least a portion of the first discount, the second discount, and the third discount are provided to the user as a response to the user's behavior in selecting, creating, and purchasing products.

13. The network-based product-fulfillment system of claim 7, wherein the dynamic price engine is configured to calculate a second price for the order based on the combination of the first discount and the third discount, wherein the checkout module is configured to facilitate the user to pay for the order at the first price or the second price chosen by the user.

14. The network-based product-fulfillment system of claim 7, wherein the first discount, the second discount, and the third discount provides different percentages or price reductions to different users, and wherein the rules are the same for the different users.

15. An intelligent electronic shopping system operated by a service provider, comprising:
a shopping cart configured to capture an order comprising one or more products selected or created by a user who has received a first discount, a second discount, and a third discount from the service provider;
a promotion rule module configured to store rules that define that the first discount is combinable with the second discount or the third discount and that the second discount and the third discount are not combinable with each other;
a dynamic price engine in communication with the promotion rule module and the shopping cart, the dynamic price engine being configured to calculate a first price for the order based on the combination of the first discount and the second discount, wherein the dynamic price engine prohibits the combination of the second discount and the third discount in computing the price for the order; and
a checkout module in communication with the shopping cart, the checkout module being configured to facilitate the user to pay for the order, wherein the order is sent to a product fulfillment center.

16. The intelligent electronic shopping system of claim 15, wherein the dynamic price engine is configured to calculate a second price for the order based on the combination of the first discount and the third discount, wherein the checkout module is configured to facilitate the user to pay for the order at the first price or the second price chosen by the user.

17. The intelligent electronic shopping system of claim 15, wherein at least a portion of the first discount, the second discount, and the third discount are received from an external source outside of the intelligent electronic shopping system.

18. The intelligent electronic shopping system of claim 15, wherein at least a portion of the first discount, the second discount, and the third discount are provided to the user as a response to the user's behavior in selecting, creating, and purchasing products.

19. The intelligent electronic shopping system of claim 15, wherein at least a portion of the first discount, the second discount, and the third discount are entered as a discount code by the user.

20. The intelligent electronic shopping system of claim 15, wherein the first discount, the second discount, and the third discount provides different percentages or price reductions to different users, and wherein the rules are the same for the different users.
